(19) United States
(12) Patent Application Publication
(10) Pub. No.: US 2026/0030892 A1
(43) Pub. Date: Jan. 29, 2026

(54) Video Surveillance System and Method for Cross-Verification of Events

(71) Applicant: Eagle Eye Networks, Inc., Austin, TX (US)

(72) Inventors: Dean Drako, Austin, TX (US); Steven Roskowski, Austin, TX (US)

(73) Assignee: Eagle Eye Networks, Inc., Austin, TX (US)

(21) Appl. No.: 19/257,741

(22) Filed: Jul. 2, 2025

Related U.S. Application Data
(60) Provisional application No. 63/675,818, filed on Jul. 26, 2024.

(51) Int. Cl. G06V 20/52; G06V 20/40; H04N 7/18

(52) U.S. Cl. CPC G06V 20/52; G06V 20/44; H04N 7/188

(57) ABSTRACT

Embodiments for cross-verification of events comprise a processor communicatively coupled to a sensor and a camera. When the sensor sends a signal indicating a condition or event, the processor analyzes a video stream from the camera to determine whether an event is occurring. Similarly, if the camera captures a video stream indicating an event is occurring, the processor determines if a sensor has sent a signal indicating a condition associated with the event.

### CROSS-REFERENCE TO RELATED APPLICATIONS

This application claims the benefit of Provisional Application 63/675,818, filed Jul. 26, 2024.

### BACKGROUND

### Field of the Disclosure

The present invention relates to video surveillance and sensor signal analyses, and more particularly for systems and methods for cross-verification of events based on video surveillance and sensor signal analyses.

### DESCRIPTION OF THE RELATED ART

Sensors are used to detect conditions (e.g., a door is opened, glass breaking, the presence of smoke, etc.). As examples, a thermal sensor may detect when a temperature exceeds a threshold value (e.g., a condition) or sense a temperature (e.g., a numerical value), and a microphone may detect sound (e.g., a condition) or capture audio information (e.g., a sound level). Cameras may be capable of capturing images including video streams.

Video systems may capture streams of video images in various settings. Typically, video streams may be viewed by security personnel to identify people or events that are out of the ordinary, wherein the determination of what is ordinary and what is out of the ordinary is subjective (e.g., the determination of what is ordinary depends on who is viewing the video).

Video monitoring systems may be useful for monitoring a range of sites, wherein each site includes one or more locations (e.g., a lobby, a hallway) and environments (e.g., indoors, outdoors, public areas, private areas) with various entities (e.g., people, animals, entities, vehicles). There are inevitably variations in attributes of entities (e.g., height) and events (e.g., the number of entities participating in the event). Some attributes may be within a range of expected variations (i.e., typical) for one environment, entity or event but the same attributes may be outside the range of expected values (i.e., atypical) for another environment, entity or event.

### SUMMARY

Embodiments disclosed herein may be directed to a method for cross-verification of an event at a site based on information received from a sensor and a video stream captured by a camera. The method comprises: receiving a signal from a sensor at a site; determining a set of possible events based on the signal; identifying a camera associated with the sensor; and analyzing a video stream from the camera to determine whether an event is occurring (or has occurred), wherein if the video stream indicates an event is occurring or has occurred, the method comprises executing a first set of instructions associated with a main process; and if the video stream indicates an event is not occurring, the method comprises executing a second set of instructions associated with an alternate process. In some embodiments, analyzing a video stream from a camera to determine whether an event is occurring comprises determining if a condition is present, wherein: if an analysis of the video stream indicates the condition is present, the method includes executing the first set of instructions; or if an analysis of the video stream indicates the condition is not present, the method includes executing the second set of instructions. In some embodiments, identifying a camera associated with the sensor is performed in response to receiving a signal. In some embodiments, identifying a camera associated with a sensor is performed in response to identifying an event based on a signal. In some embodiments, analyzing a video stream from the camera to determine whether an event is occurring comprises retrieving at least a portion of a video stream from a memory in the bridge. In some embodiments, a sensor comprises one of an electromechanical sensor, an audio sensor, a temperature sensor, a chemical sensor or a pressure sensor.

Embodiments disclosed herein may be directed to a system for cross-verification of an event at a site. The system may comprise: a sensor at the site configured to communicate a signal in response to detection of a condition; a camera capturing a video stream at the site; a bridge at the site and a data center communicatively coupled to the bridge. The bridge comprises a memory storing instructions and a processor configured to execute instructions and the data center comprises a plurality of servers, each server comprising a memory storing instructions and a processor configured to execute instructions. One or more of the bridge and a server is configured to: receive the signal from the sensor; determine an event based on the signal; and analyze the video stream from the camera to determine whether the event is occurring, wherein if the video stream indicates the event is occurring, one or more of the bridge and the server executes a first set of instructions associated with a main process; and if the video stream indicates the event is not occurring, one or more of the bridge and the server executes a second set of instructions associated with an alternate process. In some embodiments, to determine whether an event is occurring, a processor associated with one or more of the bridge and the server is configured to execute instructions to analyze a video stream to determine if a condition is present, wherein: if an analysis of the video stream indicates the condition is present, the processor executes the first set of instructions; or if an analysis of the video stream indicates the condition is not present, the processor executes the second set of instructions. In some embodiments, the processor executes the instructions to identify the camera associated with the sensor in response to receiving a signal. In some embodiments, one or more of the bridge and the server comprises a processor executing instructions to identify the camera associated with the sensor in response to determining the event based on the signal. In some embodiments, to determine whether the event is occurring, the bridge comprises a processor executing instructions to retrieve at least a portion of the video stream from the bridge memory. In some embodiments, a sensor comprises one of an electromechanical sensor, an audio sensor, a temperature sensor, a chemical sensor or a pressure sensor.

Embodiments disclosed herein may be directed to a method for cross-verification of an event at a site based on a video stream received by a bridge at the site, the bridge comprising a memory storing instructions and a processor configured to execute the instructions. The method may comprise: receiving, from a camera at the site, a video stream; determining an event based on an analysis of the video stream; identifying a sensor associated with the event captured in the video stream; and determining whether a signal from the sensor indicates the event is occurring (or has occurred), wherein if the signal indicates the event is occurring or has occurred, one or more of the bridge and the server executes a first set of instructions associated with a main process; and if the signal indicates the event is not occurring, one or more of the bridge and the server executes a second set of instructions associated with an alternate process. In some embodiments, analyzing a signal from the sensor to determine whether the event is occurring comprises one or more of the bridge and the server determining if a condition is present, wherein: if the signal indicates the condition is present, one or more of the bridge and the server executes the first set of instructions; or if the signal indicates the condition is not present, one or more of the bridge and the server executes the second set of instructions. In some embodiments, identifying a signal associated with the video stream is performed in response to an analysis of the video stream. In some embodiments, one or more of the bridge and the server comprises a processor executing instructions to identify a signal associated with the video stream in response to determining the event based on the analysis of the video stream. In some embodiments, analyzing a video stream from the camera to determine whether the event is occurring comprises a processor at one or more of the bridge and the server executing instructions to retrieve at least a portion of the video stream from the memory in the bridge. In some embodiments, the sensor comprises one of an electromechanical sensor, an audio sensor, a temperature sensor, a chemical sensor or a pressure sensor. In some embodiments, determining whether a signal from the sensor indicates the event is occurring comprises determining whether there is a signal, wherein a lack of signal indicates the event is not occurring.

To further clarify the above and other advantages and features of the present invention, a more particular description of the invention will be rendered by reference to specific embodiments thereof that are illustrated in the appended drawings.

### BRIEF DESCRIPTION OF DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system architecture of one embodiment of a network for video surveillance;

FIGS. 2-7 depict embodiments of user systems for video surveillance;

FIG. 8 is a diagram of an information handling system configurable for processing and storing information from devices associated with user locations;

FIG. 9 depicts a system diagram, illustrating one embodiment of a video surveillance system integrated with sensors for cross-verification of events captured in video streams and associated with sensor signal analyses;

FIG. 10 depicts a flow diagram of a method for cross-verification of an event corresponding to a sensor signal;

FIG. 11 depicts a flow diagram of a method for cross-verification of an event corresponding to a camera capturing a video stream;

FIG. 12 depicts a flow diagram of one embodiment of a method for cross-verification of an event corresponding to a sensor signal indicating a door is open; and

FIG. 13 depicts a flow diagram of one embodiment of a method for cross-verification of an event corresponding to a camera capturing a video stream of a person passing through a doorway.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a hypothetical entity referenced by ‘12A’ or ‘12-1’ may refer to a particular instance of a particular class/type, and the reference ‘12’ may refer to a collection of instances belonging to that particular class/type or any one instance of that class/type in general.

### Overview-Video Surveillance Systems

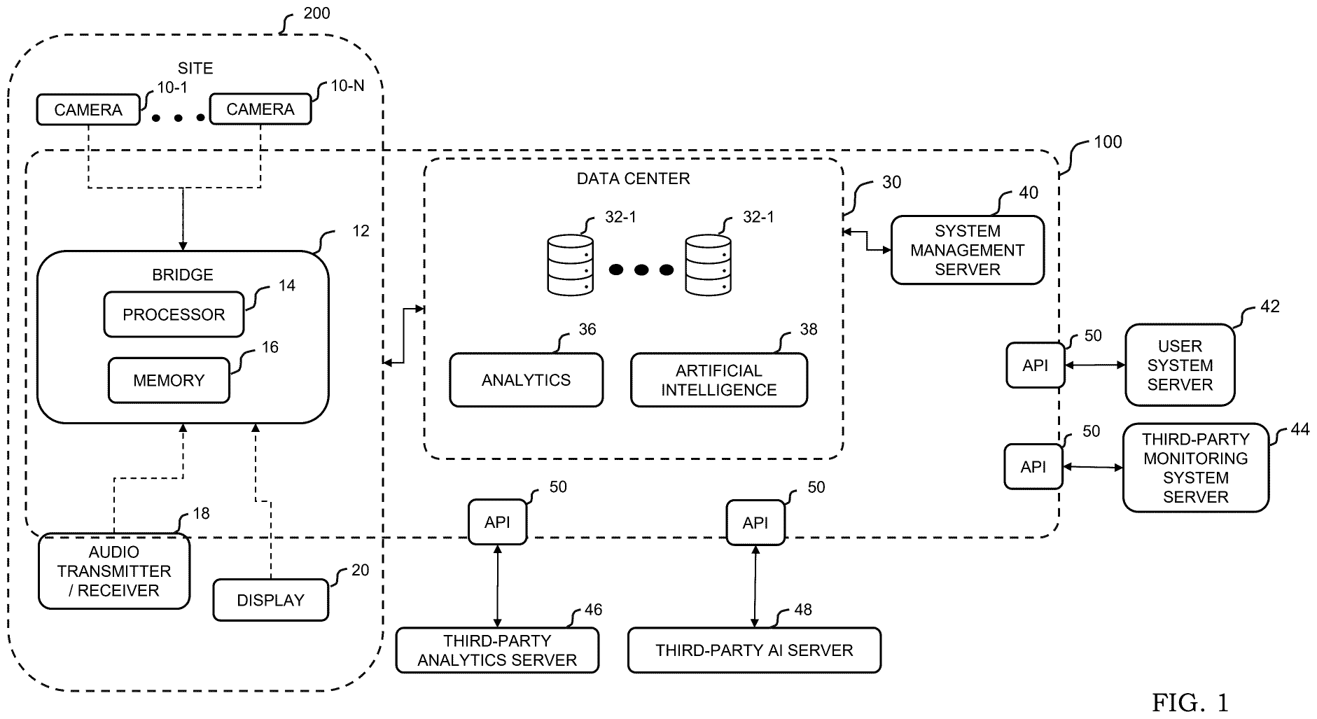

FIG. 1 depicts a system architecture of one embodiment of a video surveillance system 100 for monitoring site 200 and communicating a plurality of video frames (i.e., a video stream) from site 200 to data center 30. Site 200 may refer to a building, structure, and/or an area, any of which may include a plurality of buildings, structures, and/or areas. Data center 30 may also communicate with video surveillance control system 40, user system server 42, third-party monitoring system server 44, third party analytics server 46 and/or third-party artificial intelligence server 48.

### Cameras

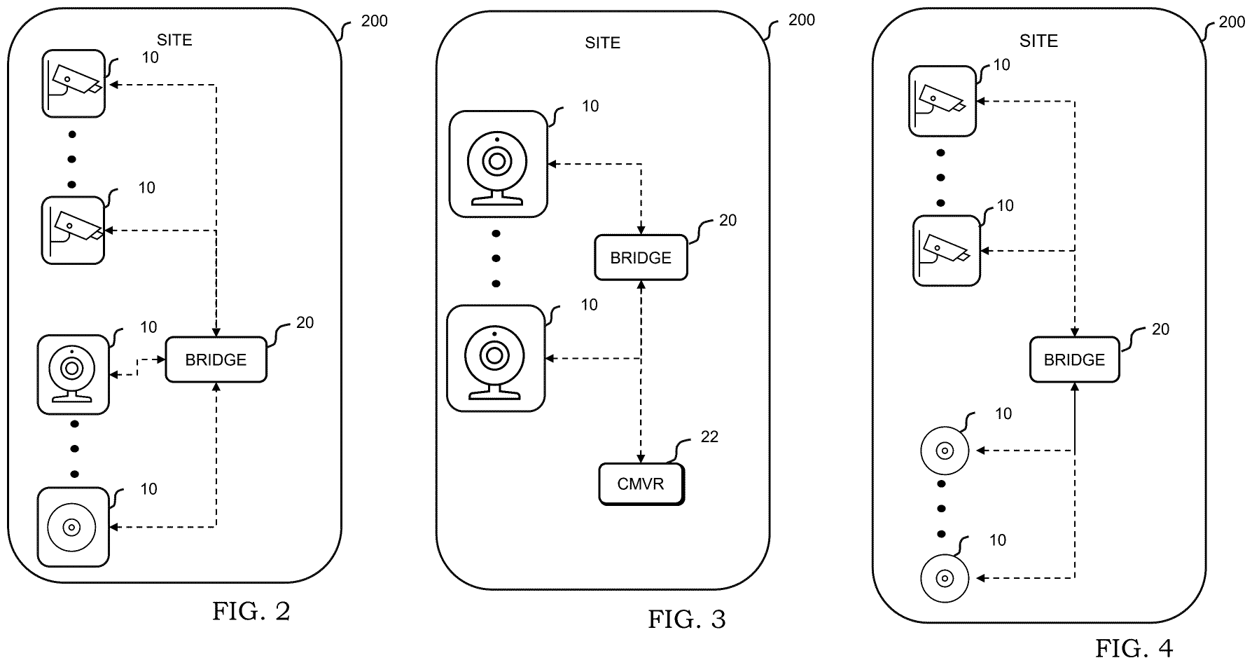

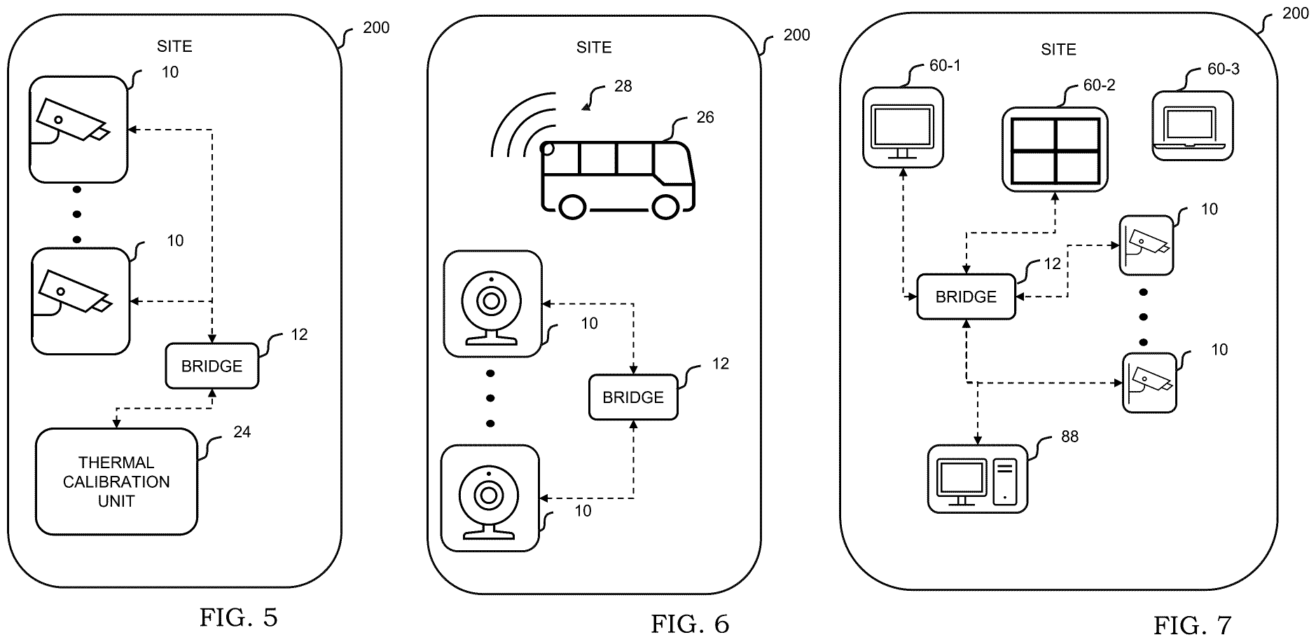

Referring to one or more of FIGS. 2-7, cameras 10 may comprise analog or digital (e.g., Internet Protocol or “IP”) cameras 10 including, but not limited to, directional cameras 10, 360-degree cameras 10, fish-eye cameras 10, black-and-white video cameras 10, color cameras 10, high-resolution cameras 10, low-resolution cameras 10 or infrared cameras 10 for capturing video information. One or more cameras 10 may comprise proprietary cameras 10 associated with Eagle Eye Networks, Inc. of Austin, Texas or may be manufactured by a third-party enterprise. A camera 10 may be located inside or outside a structure (e.g., an office building, a school, a warehouse), in a structure (e.g., parking garages and other structures not fully enclosed but providing some of the benefits of being indoors) or near an area (e.g., near elevators or an entrance to a building, near a playground, in a park, in a parking lot), discussed in greater detail below. Referring to FIG. 6, in some embodiments, cameras 10 or bridge 12 may be located in vehicle 26 with mobile network device 28 configured to communicate with data center 30 over a network (e.g., cellular or Wi-Fi), wherein vehicle 26 may be considered a site 200.

Camera information may also include, for example, information on a location of camera 10, wherein location information may include absolute information (e.g., geo-positioning system or GPS information) and/or relative location information (e.g., “the north stairwell”). Camera information may include, for example, azimuth or orientation information, wherein orientation information may comprise absolute information (e.g., angled at 45 degrees horizontally and −25 degrees vertically) and/or relative information (e.g., “angled towards the stairwell and looking down”). Camera information may include, for example, a time, a date, and/or other information to identify where and when information was captured. Camera information may include network information, such as an Internet Protocol (IP) address and/or an alias (e.g., “the main lobby camera”).

### Bridges Perform Lightweight Processing of Video Streams On-Site

Processing all video streams on-site would require significant processing resources. Constantly communicating (i.e., “streaming”) a video stream from each camera 10 to data center 30 for processing may need fewer resources on-site, but would depend on, among other things, network bandwidth. Embodiments disclosed herein may include bridge 12 at each site 200, wherein bridge 12 may be an edge device (e.g., an entry point for images and data from the physical world) configured for lightweight processing of video streams. Site 200 may include display 18 for communicating video information to a user and audio transmitter/receiver 20 for communicating audio information to or from a user.

As used herein, the term “lightweight” may refer to basic processing of individual video streams, including, but not limited to capturing a video stream, applying a timestamp, and communicating the video stream to data center 30. Lightweight processing may further comprise entity identification (e.g., vehicle recognition, license plate recognition (LPR)) and determining an attribute (e.g., determining a size attribute or nearness of an entity, determining a speed attribute, determining a number of entities, etc.) within a video stream.

Bridge 12 may execute instructions to communicate video streams and information to data center 30. Information communicated to data center 30 may include, for example, a time stamp or information about camera 10 associated with the information. In some embodiments, bridge 12 may: receive video streams and information from one or more cameras 10 and directly communicate the video streams and information to data center 30; receive video streams and information from one or more cameras 10 and analyze or process at least a portion of the video streams and information before communicating the video streams and information to data center 30; and/or receive video streams and information from one or more cameras 10 and store at least a portion of the video streams and information before communicating the video streams and information to data center 30.

Thus, communicatively coupling cameras 10 to bridges 12 and communicatively coupling bridges 12 to data center 30 may refer to directly or indirectly communicating video streams and information from cameras 10 to data center 30, communicating video streams and information from cameras 10 through bridges 12 to data center 30, and/or analyzing, processing or storing at least a portion of the video streams and information before communicating the video streams and information to data center 30. Embodiments of bridge 12 may be configured to communicate video streams and information to data center 30 in real-time, periodically (e.g., at scheduled intervals or at a scheduled time), or based on an event (e.g., in response to a predefined trigger). In some embodiments, bridge 12 may communicate a video stream to data center 30 when bridge 12 detects motion and determines an entity is present. In some embodiments, bridge 12 may communicate a video stream to data center 30 when bridge 12 detects motion and determines an entity is present and identifies the entity. In some embodiments, bridge 12 may communicate a video stream to data center 30 when bridge 12 detects motion and determines an entity is present, identifies the entity and determines a set of entity attributes.

Memory 16 may store video information including one or more video streams, information about the video streams (e.g., timestamps), and information about the cameras 10 (e.g., information about a site 200 at which camera 10 is located, a location of camera 10 at site 200, a direction in which each camera 10 is aimed, etc.).

### Data Centers

Data center 30 may refer to a plurality of servers 32 or other information handling systems configured for processing video streams for smart video surveillance and storing information including video streams, analytics on video streams and data associated with video streams. Data center 30 may be located at a single location or may be located at a collection of locations (e.g., a “cloud” system 34) such that video streams and other information received from hundreds or even thousands of cameras 10 may be received, processed, stored, and accessed as needed. Data center 30 may be communicatively coupled to system management server 40, one or more user system servers 42 and one or more third-party monitoring system servers 44. Data center 30 may also be communicatively coupled to third party analytics server 46 and/or third-party artificial intelligence (AI) server 48. User system servers 42, third-party monitoring system servers 44, third-party analytics servers 46 and third-party AI servers 48 may be communicatively coupled to data center 30 through Application Programming Interfaces (APIs) 50.

User system server 42 may refer to an information handling system having a processor and memory storing a set of instructions executable by the processor to allow a user associated with site 200 to access video streams and video information about site 200, configure permissions for cameras 10 and memory 16 located on-site, etc.

Third-party monitoring system server 44 may refer to an information handling system having a processor and memory storing a set of instructions executable by the processor to allow a user with a third-party monitoring system server 44 to view and/or access video streams. An API 50 for third-party monitoring system server 44 may be instantiated specifically for third-party monitoring system server 44 and therefore may be different than other APIs 50 for user system server 42, third-party analytics server 46 or third-party artificial intelligence (AI) server 48.

Third-party analytics server 46 may refer to an information handling system having a processor and memory storing a set of instructions executable by the processor to allow a user with a third-party analytics server 46 to analyze content in video streams. API 50 for third-party analytics server 46 may be instantiated specifically for the third-party analytics server 46 and therefore may be different than other APIs 50 for user system server 42, third-party monitoring system server 44 or third-party artificial intelligence server 48.

Third-party artificial intelligence (AI) server 48 may refer to an information handling system having a processor and memory storing a set of instructions executable by the processor to analyze content in video streams. API 50 for third-party artificial intelligence systems 48 may be instantiated specifically for third-party AI systems 48 and therefore may be different than other APIs 50 for user system server 42, third-party monitoring system server 44 or third-party analytics server 46.

### Data Center Information Processing

In some embodiments, information processing by data center 30 may be more robust (i.e. “heavier” weighted than processing at bridge 12) and comprise analyzing information from one or more cameras 10 from one or more sites 200. For example, information processing at bridge 12 may include determining a person is present, while information processing at data center 30 may include determining, based on one or more of the size of the person being less than a minimum threshold, the speed of the person is higher than average, or some other attribute, that the person is a child. Data center 30 may perform processing of information to determine a maximum threshold (e.g., maximum temperature, sound level or illumination) associated with camera 10, a resolution of camera 10, a frame per second (FPS) processing speed of camera 10, a latency of camera 10, a transmission protocol, or some other information associated with the capabilities of camera 10 for recording and transmitting information.

### Information Handling Systems

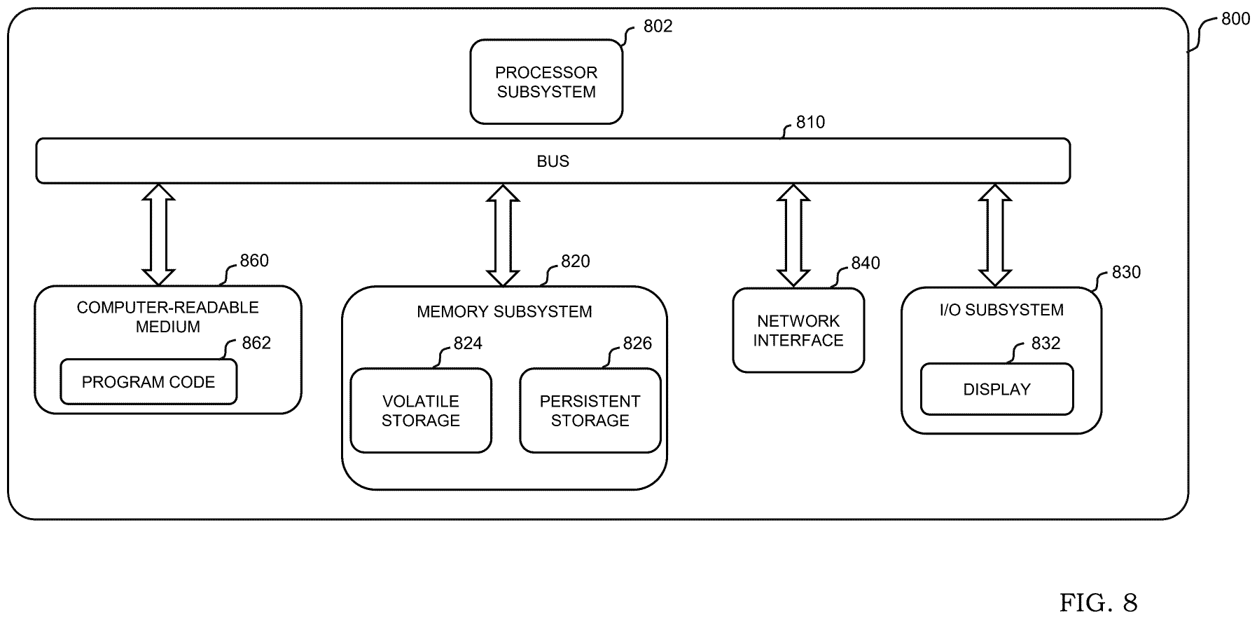

Referring to FIG. 8 and one or more of FIGS. 1, 6 and 7, data center 30, system control center 40, user system 50, third-party systems 60, third-party analytics 70 and third-party artificial intelligence (AI) systems 80 may comprise embodiments of information handling systems 800. FIG. 8 depicts information handling system 800 capable of administering several of the embodiments of the present disclosure. Information handling system 800 may include processor subsystem 802 communicatively coupled via system bus 810 to memory subsystem 820, input/output (I/O) subsystem 830 and network interface 840.

Processor subsystem 802 may comprise a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 802 may interpret and execute program instructions and process data stored locally (e.g., in memory subsystem 820). In the same or alternative embodiments, processor subsystem 802 may interpret and execute program instructions and process data stored remotely (e.g., in a network storage resource). Processor subsystem 802 may include components such as a central processing unit (GPU) and a graphics processing unit (GPU).

System bus 810 may refer to a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 820 may comprise a system, device, or apparatus operable to retain and retrieve program instructions and data for a period (e.g., computer-readable media). Memory subsystem 820 may comprise one or more volatile storage 824 and persistent storage 826. Storage may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed.

I/O subsystem 830 may comprise a system, device, or apparatus operable to receive and transmit data to or from or within information handling system 800. I/O subsystem 830 may represent, for example, a variety of communication interfaces, graphics interfaces, video interfaces, user input interfaces, and peripheral interfaces. In various embodiments, I/O subsystem 830 may be used to support various peripheral devices, such as a touch panel, a display adapter, a keyboard, an accelerometer, a touch pad, a gyroscope, or a camera, among other examples. In some implementations, I/O subsystem 830 may support so-called ‘plug and play’ connectivity to external devices, in which the external devices may be added or removed while information handling system 800 is operating. In some embodiments, information handling system 800 may further include display 832. Display 832 may be of a variety of display types, such as a liquid crystal display (LCD), an organic light emitting diode (OLED), a flat panel display, a solid-state display, or a cathode ray tube (CRT). Display 832 may include one or more touch screen display modules and touch screen controllers for receiving user inputs to information handling system 800. Additionally, information handling system 800 may include an input device, such as a keyboard, and a cursor control device, such as a mouse or touchpad or similar peripheral input device.

Network interface 840 may be a suitable system, apparatus, or device operable to serve as an interface between information handling system 800 and a network (not shown). Network interface 840 may enable information handling system 800 to communicate over the network using a suitable transmission protocol or standard. In some embodiments, network interface 840 may be communicatively coupled via the network to a network storage resource (not shown). The network coupled to network interface 840 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 840 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 840 or various components associated therewith may be implemented using hardware, software, or any combination thereof.

Still referring to FIG. 8, computer program product 860 may comprise computer-readable media 860 storing program code 862. Program code 862 may be loaded onto or transferred to information handling system 800 for running by processor subsystem 802.

Cameras May be Associated with a Site

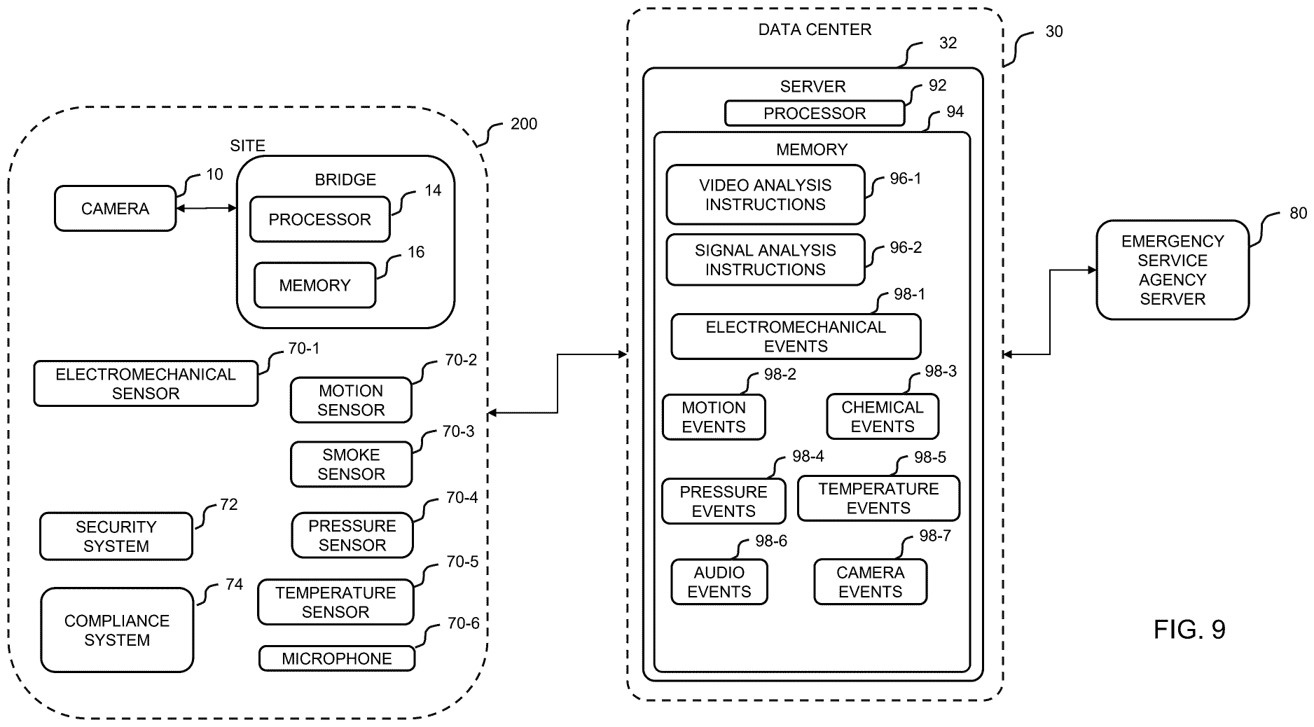

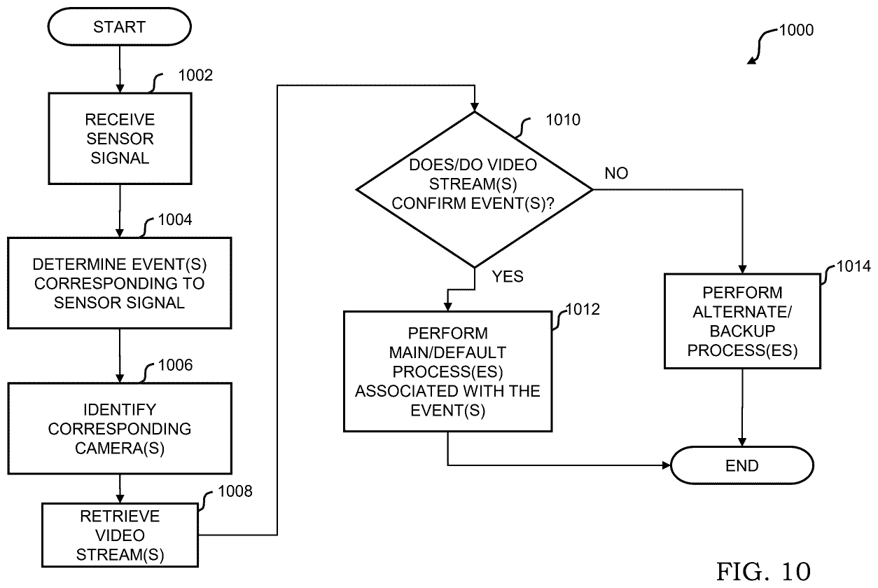

Turning to FIG. 9, embodiments of systems disclosed herein may be configured to enable a video surveillance system to verify a sensor signal and/or a condition associated with a sensor signal and/or an event associated with a condition or a sensor signal. Embodiments disclosed herein may be configured to allow or even trigger sensor signal analyses to verify video surveillance analysis.

A Site May have Sensors as Well as Cameras

Referring to FIG. 9, site 200 may have cameras 10 and bridge 12 forming part of a video surveillance system as described above. Also depicted in FIG. 9, site 200 may include a set of sensors 70, security system server 72 and compliance system server 74. Sensors 70 may include electromechanical sensor 70-1, motion sensor 70-2, smoke sensor 70-3, pressure sensor 70-4, temperature sensor 70-5 and microphone 70-6. Other sensors 70 (e.g., badge scanners, biometric scanners, radio frequency identification (RFID) scanners) are also possible.

Sensors 70 detect or sense conditions at site 200. Detection may refer to a simple determination of a condition (e.g., sound is present), and sensing may refer to more information (e.g., a sound level measurement). Conditions may be associated with one or more events. For example, an electromechanical sensor 70-1 may be configured to send a signal when a door is open (a condition), which may be associated with one or more events (e.g., one or more persons passing through a doorway to enter a building, one or more persons passing through the doorway to exit the building, or some combination of people entering and exiting the doorway).

Cameras 10 and sensors 70 may be selected, positioned and orientated to capture information. For example, a thermal sensor 70 may be selected and positioned to detect a fire in a room, a motion sensor 70 may be positioned and oriented to detect any movement in a hallway, a 360-degree camera 10 may be selected and positioned near an elevator or in a room to capture information relating to movement of people, a directional camera 10 may be positioned and directed toward a door to capture information relating to movement of people through the door or positioned and directed toward a gate to capture information relating to movement of vehicles through the gate.

Data center 830 may comprise a plurality of servers 32, wherein server 32 may comprise processor 92 executing a set of instructions 96 stored in memory 94. Memory 94 may also store one or more data structures 98 corresponding to events that correspond to one or more conditions detectable by sensors 70.

Sensor Signals May be Associated with Conditions

A signal may be a simple (e.g., binary, one-time, or discrete) signal associated with a condition. For example, a glass break sensor may be an electromechanical sensor that detects vibrations or an audio sensor that detects the sound of glass breaking, wherein the sensor associates the vibrations or sound with glass breaking and sends a communication indicating a condition (e.g., a broken window). A contact sensor (sometimes called a magnetic switch) to detect an open door may be comprised of a magnet and a sensor. When the door is opened, the magnet is withdrawn, disrupting the magnetic field (opening the circuit). When the door is closed, the magnet is returned, completing the magnetic field (closing the circuit). For other sensors, a signal may be more complex (e.g., continuous, multivariate, numerical). For example, when an audio sensor detects a sound, the sensor may send a signal indicating a type of sound or a numerical signal indicating a sound level. Sensors 70 may detect other conditions and other signals or combinations of signals may be sent for analysis.

Conditions May be Associated with Events

A signal may indicate a condition, and a condition may be associated with one or more events. For example, a sensor 70 may indicate a door is open (e.g., a condition). The condition may be associated with one or more events (e.g., one or more persons entering a building, one or more persons exiting the building, a combination of one or more persons entering the building and one or more persons exiting the building, wind has blown open the door, etc.). Furthermore, a list of possible events may include variations. For example, a person may enter a door legally or illegally. More than one condition may be associated with an event. For example, a person entering a building may be associated with a door sensor 70 indicating a door is open and may also be associated with an audio sensor 70 or temperature sensor 70 indicating the presence of somebody near the door. Thus, a signal may be associated with more than one event, causing uncertainty in a security system based only on sensors 70.

Data center memory 94 and/or bridge memory 16 may store one or more data structures 98 associating events with conditions possible at site 200. In some embodiments, data center memory 94 may store data structures 98 defining relationships for a plurality of sensor signals to conditions and/or events possible at all sites 200, wherein bridge memory 16 may store a data structure defining relationships for a set of sensor signals to conditions and/or events specific to a single site 200, wherein the set of sensor signals is less than or equal to the plurality of sensor signals. In some embodiments, bridge memory 16 may store one or more data structures 98 defining relationships for only sensors 70, conditions or events associated with site 200.

In some embodiments, data center memory 94 and/or bridge memory 16 may store data structure 98-1 including electromechanical events associated with control systems, transportation systems and material handling systems including doors, windows, valves, elevators, escalators, conveyor systems and robotics/robots. Electromechanical events may comprise, for example, a simple sensor signal associated with a door indicating the door is locked or unlocked, open or closed, operational or non-operational (e.g., jammed, propped open, etc.), or some other state. Electromechanical events may be more advanced and include other information such as how long a door remained open (which may be an indicator that more than one person passed through the door) or how quickly a door opened or closed (which may be an indicator that the wind blew the door open or shut) or some other quantity, level or threshold.

In some embodiments, data center memory 94 and/or bridge memory 16 may store data structure 98-2 including motion events associated with rooms, hallways, areas or buildings. Motion events may be simple events, such as an indication that an object is moving (or not moving), wherein the object may be an object (e.g., a ladder, a desk), an animal (e.g., dog, cat), a person or people, and a vehicle. A more advanced motion event may indicate, for example, a speed of the object being greater than a maximum speed threshold.

In some embodiments, data center memory 94 and/or bridge memory 16 may store data structure 98-3 including chemical events associated with the presence of, for example, smoke, gas or vapor that may hinder vision, breathing or movement. A simple smoke event may indicate smoke is present, whereas a more advanced smoke event may indicate, for example, a level of vapor known to cause eye irritation.

In some embodiments, data center memory 94 and/or bridge memory 16 may store data structure 98-4 including pressure events such as a sensor signal indicating, for example, the presence of or contact with an object. For example, a pressure plate may be positioned under a street, wherein a pressure event may indicate, for example, the presence of a vehicle or may indicate the weight of a vehicle.

In some embodiments, data center memory 94 and/or bridge memory 16 may store data structure 98-5 including temperature events such as a sensor signal indicating, for example, the ambient temperature in a room is greater than a maximum temperature threshold (or less than a minimum temperature threshold). Other temperature events may be more advanced, including the actual temperature in a room, or a fluid temperature in a process is within a range of acceptable temperatures.

In some embodiments, data center memory 94 and/or bridge memory 16 may store data structure 98-6 including audio events, which may comprise a basic sensor signal, for example, indicating sound in a room. More advanced audio sensor signals may indicate, for example, a sound level in a room. Audio events may comprise audio sensor signals related to the presence of a person or people, the presence of an animal, the presence of a vehicle. Audio events may also comprise audio sensor signals related to a process (e.g., sounds associated with machinery).

In some embodiments, data center memory 94 and/or bridge memory 16 may store data structure 98-7 including camera events, which may comprise basic video events such as a camera capturing motion or more advanced events such as a camera capturing motion and storing text summarizing the motion (e.g., a person running).

### Information Processing for Smart Video Surveillance

In some embodiments, information processing may comprise analyzing information from one or more cameras 10. For example, information may include determining a manufacturer of camera 10, an accuracy of camera 10, a minimum threshold (e.g., minimum sound level, illumination or temperature) associated with device 10, a maximum threshold (e.g., maximum temperature, sound level or illumination) associated with device 10, a resolution of camera 10, a frame per second (FPS) processing speed of camera 10, a latency of device 10, a transmission protocol, or some other information associated with the capabilities of device 10 for recording and transmitting information. Device information may also include, for example, information on a location of device 10, wherein location information may include absolute information (e.g., geo-positioning system or GPS information) and/or relative location information (e.g., “the north stairwell”). Device information may include, for example, azimuth or orientation information, wherein orientation information may comprise absolute information (e.g., angled at 45 degrees horizontally and −25 degrees vertically) and/or relative information (e.g., “angled towards the stairwell and looking down”). Device information may include, for example, a time, a date and/or other information to identify where and when information was captured. Device information may include network information, such as an Internet Protocol (IP) address and/or an alias (e.g., “the main lobby camera”).

### A Sensor Signal May Prompt Analysis/Analyses of a Video Stream

FIG. 9 depicts flow diagram 900, illustrating one embodiment of a method for cross-verification of an event that was determined based on a sensor signal.

At step 1002, embodiments receive a signal from sensor 70 associated with a site. In some embodiments processor 14 at bridge 12 receives the signal. In some embodiments, processor 92 at server 32 receives the signal.

At step 1004, embodiments analyze the sensor signal and determine one or more events that may correspond to the sensor signal. For example, if the sensor signal corresponds to a door opening, embodiments may determine there are two events that may correspond to a door opening: 1) a person is entering the door, and 2) a person is exiting the door. In some embodiments, processors 14 and/or 92 may each determine an event or set of events that may correspond to the sensor signal.

At step 1006, embodiments identify one or more cameras 10 corresponding to the event(s). For example, in a scenario in which a door sensor signal indicates the door is opening, embodiments may identify cameras 10 on each side of the door.

At step 1008, embodiments analyze video streams. In some embodiments, servers 32 at data center 30 communicate with cameras 10 and/or memory 16 to retrieve one or more video streams associated with sensor 70 or event. For example, if embodiments determine a set of possible events for a door being open includes a person entering a building, processor 92 may retrieve video streams for cameras 10 associated with an exterior of the building to see if multiple people were outside before the door opened (and what they were doing) and retrieve video streams for cameras 10 associated with an interior of the building to see if multiple people were inside before the door opened (and what they were doing).

At step 1010, embodiments determine if one or more video streams confirm an event or events. For example, if a door sensor 70 indicates a door is open, processor 14 may analyze a video stream from a single camera 10 or processor 92 may access video streams from one or more cameras 10 and determine 1) the door was opened by a person exiting the building; 2)) the door was opened by a person entering the building; 3) the door was opened by a person exiting the building but somebody entered the building without scanning their badge; 4) the door was opened by a person entering the building but additional people entered the building without scanning their badge; or 5) the wind blew the door open.

If, at step 1010, processor determines one or more video streams confirm an event or events, then at step 1012, processor 14 and/or processor 92 performs one or more main or default processes associated with the event(s) detected by sensors 70 and confirmed by video stream analyses. For example, if a door was opened and a person entered a building, a main/default process may be to increase an occupancy count to include the person or persons entering the building.

If, at step 1010, processor 14 and processor 92 cannot determine whether one or more video streams confirm an event or determines the event or events did not happen, then at step 1014, processor 14 and/or processor 92 performs one or more alternate or backup processes associated with the event(s) detected by sensors 70. Alternate processes may include retrieving video streams from other cameras 10 and analyzing those video streams, communicating with other sensors 70 to see if there is additional sensor information that may be helpful, communicating with a user via security system server 40 to alert them of a problem, etc.

### Video Stream Analysis/Analyses May Trigger Sensor Signal Capture

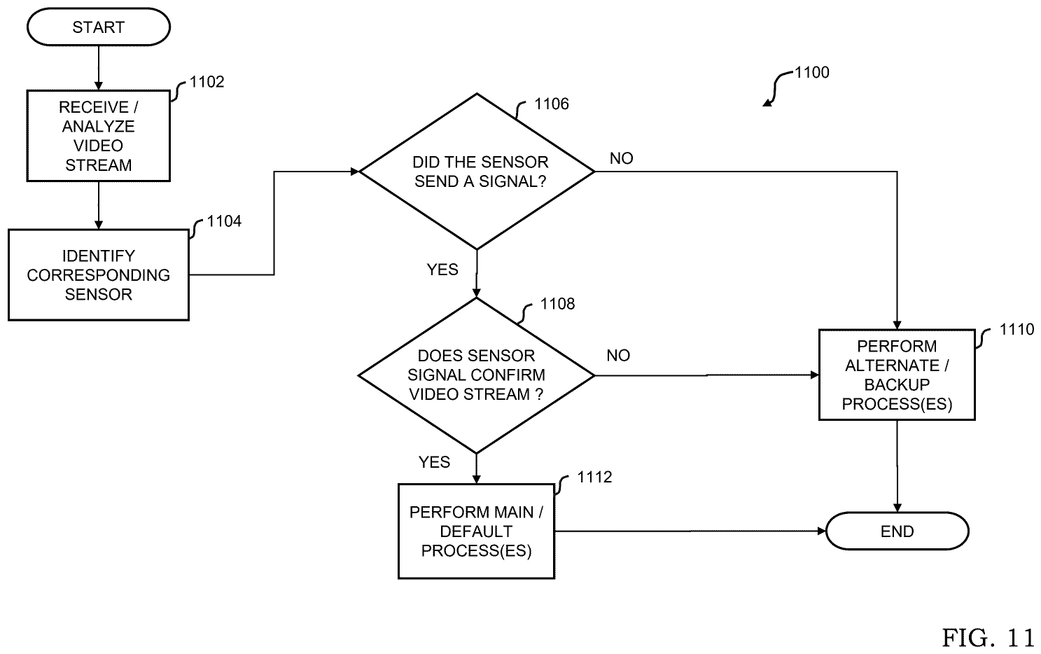

In some embodiments, analysis of a video stream may trigger a sensor 70 to capture a signal. FIG. 11 depicts a flow diagram 1100 of a method for triggering a sensor 70 to capture a signal in response to an analysis of a video stream.

At step 1102, embodiments may analyze a video stream received from camera 10. In some embodiments, processor 14 at bridge 12 may perform lightweight processing of a video stream.

At step 1104, embodiments may identify a corresponding sensor 70. Identifying a corresponding sensor 70 may comprise determining a location (e.g., Global Positioning System (GPS) coordinates, latitude/longitude, semantic location such as “the stairwell”, etc.). Identifying a corresponding sensor 70 may comprise determining a type of sensor 70. For example, if processor 14 and/or processor 92 determines camera 10 is capturing a video stream of smoke, a processor may determine a smoke sensor 70 is the best or correct sensor, but processor 14 and/or processor 92 may also identify a motion sensor 70 (e.g., to determine if people are present), a temperature sensor 70 (e.g., to sense the temperature), or a chemical sensor (e.g., to determine the presence of a chemical).

At step 1106, embodiments determine whether a sensor sent a signal that corresponds to the video stream.

If, at step 1106, embodiments determine that a sensor did not send a signal that corresponds to the video stream, then at step 1110, embodiments may perform alternate or backup processes.

If, at step 1106, embodiments determine that a sensor sent a signal that corresponds to the video stream, then at step 1108, embodiments determine if the sensor signal confirms the video stream analysis.

If, at step 1108, embodiments determine an analysis of the sensor signal confirms the video stream analysis, then, at step 1112, processor 14 and/or processor 92 may perform main or default processes. Thus, if video stream analysis indicates a person passed through a door and sensor signal analysis indicates the door was opened or is still open, processor 14 and/or processor 92 may execute one or more main processes.

If, at step 1108, a processor determines an analysis of the sensor signal does not confirm the video stream analysis, then at step 1112, processor 14 and/or processor 92 may perform main or default processes at step 1110. Performing alternate or backup processes may comprise notifying a security system server of a possible breach in security, notifying a maintenance server of a possible issue with sensor 70, etc.

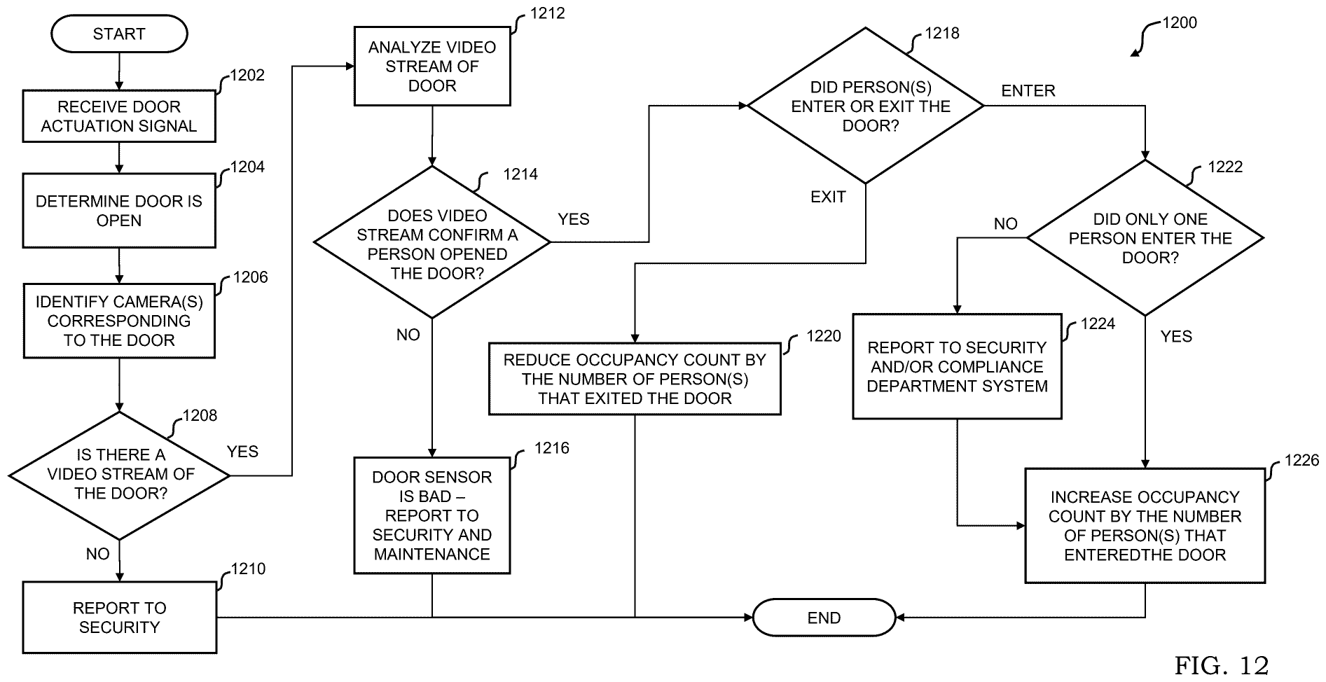

FIG. 12 depicts flow diagram 1200 illustrating a method for cross-verification of a particular, non-limiting event initially detected by a sensor 70.

At step 1202, embodiments may receive a door actuation signal.

At step 1204, embodiments analyze the door actuation signal and determine that a door is open.

At step 1206, embodiments identify one or more cameras 10 corresponding to the door and capture a video stream corresponding to the door.

At step 1208, embodiments determine if there is a video stream of the door.

If, at step 1208, embodiments determine there is not a video stream of the door, then at step 1210, embodiments may report the event to a security system.

If, at step 1208, embodiments determine there is a video stream of the door, then at step 1212, embodiments may analyze the video stream of the door.

At step 1214, embodiments may determine whether analysis of the video stream confirms a person opened the door.

If, at step 1214, processor 14 determines a person did not open the door, then at step 1216, embodiments may determine the door sensor is bad and report the incident to a security system and/or notify a maintenance system that the door sensor is faulty.

If, at step 1214, processor 14 determines a person opened the door, then at step 1218, embodiments may determine if the person (or persons) entered or exited the door.

If, at step 1218, embodiments determine a person (or persons) exited the door, then at step 1220, embodiments may count the number of people exiting the door and reduce the occupancy count by the number of people exiting the door.

If, at step 1218, embodiments determine a person (or persons) entered the door, then at step 1222, embodiments may determine if only one person entered the door.

If, at step 1222, embodiments determine only one person entered the door, then at step 1226, embodiments may increase the occupancy accordingly.

If, at step 1222, embodiments determine more than one person entered the door, then at step 1224, embodiments may report the incident to a security system and/or report the incident to a compliance system. Reporting an incident to a security system and/or a compliance system may include sending a portion (e.g., a “clip”) of a video stream showing what happened.

Regardless of the number of people detected entering the door, at step 1226, embodiments count the number of people entering the door and increase the occupancy count accordingly.

In one or more embodiments, portions or all of the processing for flow 1200 may be performed by processor 14 or data center processor 92 instead of or in addition to processing by processor 14.

### Exemplary Flow Diagram for a Video Stream Analysis and Corresponding Sensor Signal Analysis Verification

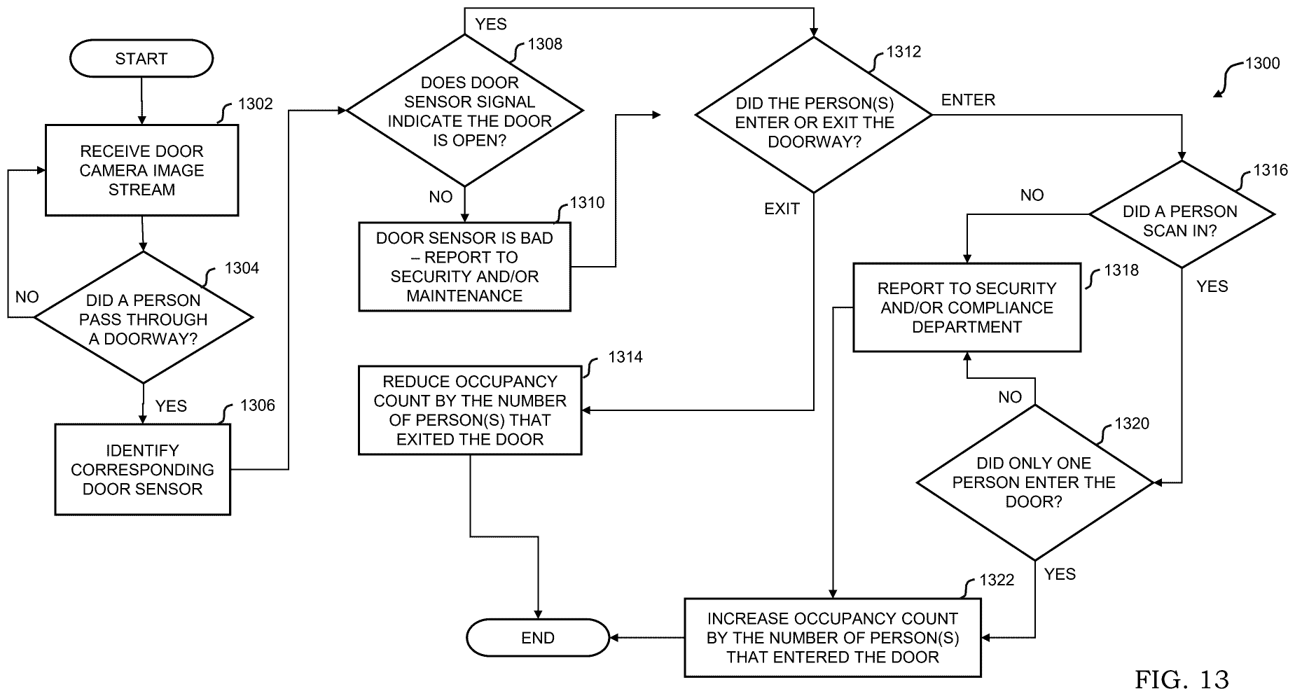

FIG. 13 depicts flow diagram 1300 illustrating a process for verification of a video stream analysis indicating a person has entered a door.

At step 1302, embodiments receive a video stream from a camera 10 associated with a door, wherein the video stream contains images of a door.

At step 1304, embodiments determine a person passed (or is passing) through the doorway.

At step 1306 embodiments identify a corresponding door sensor 70. In some embodiments, processor 14 at bridge 12 associated with camera 10 identifies one or more sensors 70 at site 200. In some embodiments, processor 92 at server 32 identifies one or more sensors 70 at one or more sites 100.

At step 1308, embodiments determine if the door sensor 70 sent (or is sending) a signal indicating the door is open.

If, at step 1308, embodiments determine the door sensor 70 did not send (or is not sending) a signal indicating the door is open, then, at step 1310 embodiments may determine there is an issue with the door sensor 70 or determine there is an issue with camera 10 and may report the incident to a security system and/or a maintenance system.

If, at step 1308, embodiments determine the door sensor 70 sent (or is sending) a signal indicating the door is open, then, at step 1312, embodiments may determine if the person (or persons) entered or exited the door.

If, at step 1212, embodiments determine a person (or persons) exited the door, then at step 1314, embodiments may count the number of people exiting the door and reduce the occupancy count by the number of people exiting the door.

If, at step 1312, embodiments determine a person (or persons) entered the door, then at step 1316, embodiments may determine if the person scanned in.

If, at step 1316, embodiments determine the person did not scan in, then at step 1318, embodiments may report the incident to security system and/or a compliance department system and at step 1322, increase the occupancy count by the number of persons that entered the door.

If, at step 1316, embodiments determine that a person scanned in, then at step 1320, embodiments may determine whether only a single person entered the door.

If, at step 1320, embodiments determine only a single person entered the door, then embodiments may determine the system is working as intended and, at step 1322, count the number of people entering the door (and increase the occupancy count accordingly).

If, at step 1320, processor 14 determines more than one person entered the door, then at step 1318, embodiments may report the incident to a security system and/or report the incident to a compliance system. Reporting an incident to a security system and/or a compliance system may include sending a portion (“clip”) of a video stream showing what happened.

Regardless of the number of people entering the door, at step 1322, embodiments count the number of people entering the door and increase the occupancy count accordingly.

In one or more embodiments, portions or all of the processing for flow 1300 may be performed by processor 14 or data center processor 92 instead of or in addition to processing by processor 14.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method for cross-verification of an event at a site, the method comprising:
receiving a signal from a sensor at a site;
determining a set of possible events based on the signal;
identifying a camera associated with the sensor; and
analyzing a video stream from the camera to determine whether an event of the set of possible events is occurring, wherein
if the video stream indicates an event of the set of possible events is occurring:
identifying the event of the set of possible events; and
executing a first set of instructions associated with a main process; and
if the video stream indicates no event of the set of possible events is occurring:
executing a second set of instructions associated with an alternate process.

2. The method of claim 1, wherein analyzing a video stream from the camera to determine whether the event is occurring comprises determining if a condition is present, wherein:
if the video stream indicates the condition is present, executing the first set of instructions; or
if the video stream indicates the condition is not present, executing the second set of instructions.

3. The method of claim 1, wherein identifying a camera associated with the sensor is performed in response to receiving the signal.

4. The method of claim 1, wherein identifying a camera associated with the sensor is performed in response to determining the event based on the signal.

5. The method of claim 1, wherein analyzing a video stream from the camera to determine whether the event is occurring comprises retrieving at least a portion of the video stream from the memory in the bridge.

6. The method of claim 1, wherein the sensor comprises one of an electromechanical sensor, an audio sensor, a temperature sensor, a chemical sensor or a pressure sensor.

7. A system for cross-verification of an event at a site, the system comprising:
a sensor at the site configured to communicate a signal in response to detection of a condition;
a camera capturing a video stream at the site;
a bridge at the site, the bridge comprising a memory storing instructions and a processor configured to execute the instructions to:
receive the signal from the sensor;
determine an event based on the signal; and
analyze the video stream from the camera to determine whether the event is occurring, wherein
if the video stream indicates the event is occurring, the bridge executes a first set of instructions associated with a main process; and
if the video stream indicates the event is not occurring, the bridge executes a second set of instructions associated with an alternate process.

8. The system of claim 7, wherein, to determine whether the event is occurring, the bridge is configured to execute instructions to analyze a video stream to determine if a condition is present, wherein:
if the video stream indicates the condition is present, the bridge executes the first set of instructions; or
if the video stream indicates the condition is not present, the bridge executes the second set of instructions.

9. The system of claim 7, wherein the processor executes the instructions to identify the camera associated with the sensor in response to receiving the signal.

10. The system of claim 7, wherein the processor executes the instructions to identify the camera associated with the sensor in response to determining the event based on the signal.

11. The system of claim 7, wherein, to determine whether the event is occurring, the processor executes instructions to retrieve at least a portion of the video stream from the memory in the bridge.

12. The system of claim 7, wherein the sensor comprises one of an electromechanical sensor, an audio sensor, a temperature sensor, a chemical sensor or a pressure sensor.

13. A method for cross-verification of an event at a site based on a video stream received by a bridge at the site, the bridge comprising a memory storing instructions and a processor configured to execute the instructions, the method comprising:
receiving, from a camera at the site, a video stream;
determining an event based on an analysis of the video stream;
identifying a sensor associated with the event captured in the video stream; and
determining whether a signal from the sensor indicates the event is occurring, wherein
if the signal indicates the event is occurring, executing a first set of instructions associated with a main process; and
if the signal indicates the event is not occurring, executing a second set of instructions associated with an alternate process.

14. The method of claim 13, wherein analyzing a signal from the sensor to determine whether the event is occurring comprises determining if a condition is present, wherein:
if the signal indicates the condition is present, executing the first set of instructions; or
if the signal indicates the condition is not present, executing the second set of instructions.

15. The method of claim 13, wherein identifying a signal associated with the video stream is performed in response to an analysis of the video stream.

16. The method of claim 13, wherein identifying a signal associated with the video stream is performed in response to determining the event based on the analysis of the video stream.

17. The method of claim 13, wherein analyzing a video stream from the camera to determine whether the event is occurring comprises retrieving at least a portion of the video stream from the memory in the bridge.

18. The method of claim 13, wherein the sensor comprises one of an electromechanical sensor, an audio sensor, a temperature sensor, a chemical sensor or a pressure sensor.

19. The method of claim 13, wherein determining whether a signal from the sensor indicates the event is occurring comprises determining whether there is a signal.

20. The method of claim 19, wherein a lack of signal indicates the event is not occurring.
